(19) United States
(12) Patent Application Publication
(10) Pub. No.: US 2019/0370703 A1
(43) Pub. Date: Dec. 5, 2019

(54) Interactive Travel Dolls and Methods of Providing Interactive Travel Experience

(71) Applicant: Allison R. Okon, Dallas, TX (US)

(72) Inventor: Allison R. Okon, Dallas, TX (US)

(21) Appl. No.: 16/426,648

(22) Filed: May 30, 2019

Related U.S. Application Data
(60) Provisional application No. 62/677,770, filed on May 30, 2018.

(51) Int. Cl. G06Q 10/02; A63H 3/00; A63H 3/36

(52) U.S. Cl. CPC G06Q 10/025; A63H 2200/00; A63H 3/36; A63H 3/003

(57) ABSTRACT

An interactive travel doll comprises a doll and a user interface configured to receive consumer input and to provide a travel plan for the doll based on the consumer input. A method of providing an interactive travel experience comprises providing a doll having a unique identification code, receiving consumer input comprising at least one of travel preferences and responses to a market driven questionnaire about travel aspirations, generating a travel plan comprising at least one trip for the doll based on the consumer input, and displaying an image of the doll during the at least one trip based on the unique identification code.

### CROSS REFERENCE TO RELATED APPLICATION

The present application claims benefit of priority under 35 U.S.C. 119(e) to the filing date of U.S. Provisional Patent Application 62/677,770, filed on May 30, 2018, entitled, “INTERACTIVE TRAVEL DOLLS AND METHODS OF PROVIDING INTERACTIVE TRAVEL EXPERIENCE,” the contents of which are incorporated herein by reference in their entirety.

### TECHNICAL FIELD

The present disclosure relates generally to interactive toys and more specifically to interactive travel dolls for young children.

### SUMMARY

According to one aspect of the present disclosure, there is provided an interactive travel doll comprising a doll and a user interface configured to receive consumer input and to provide a travel plan for the doll based on the consumer input. The consumer input may comprise at least one of travel preferences and responses to a market driven questionnaire about travel aspirations. The travel plan may comprise at least one trip. The at least one trip may comprise one or more of a USA destination, at least one international destination and a philanthropic trip.

The user interface may be further configured to display an image of the doll at a destination within the travel plan. The user interface may be further configured to provide real time travel updates during a trip within the travel plan.

In various embodiments, the interactive travel doll may further comprise a passport for the doll. The user interface may be further configured to provide passport stamps corresponding to one or more destinations within the travel plan.

The doll may have a unique identification code. The unique identification code may be associated with an image of the doll. The user interface may be configured to display the image of the doll during travel based on the unique identification code.

In some embodiments, the user interface may further comprise a social media site.

In some embodiments, the interactive travel doll may further comprise an airplane seat for the doll. Some embodiments may further comprise a travel companion pet for the doll. The travel companion pet may have a unique identification number, similar to the doll.

According to another aspect, there is disclosed a method of providing an interactive travel experience. The method may comprise providing a doll having a unique identification code, receiving consumer input comprising at least one of travel preferences and responses to a market driven questionnaire about travel aspirations, and generating a travel plan comprising at least one trip for the doll based on the consumer input. In some embodiments, the method may further comprise displaying an image of the doll during the at least one trip based on the unique identification code.

In various embodiments, the method may further comprise providing a passport for the doll, and generating passport stamps corresponding to the at least one trip. In various embodiments, generating a travel plan may comprise generating at least one of a trip to a USA destination, a trip to an international destination and a philanthropic trip. In some embodiments, the method may further comprise providing real time travel updates during the at least one trip. Some embodiments may further comprise providing access to a social media platform for the doll.

### DETAILED DESCRIPTION

Various embodiments are directed to providing interactive travel dolls, which may include dolls and related interactive travel software for young children. Embodiments are also directed at methods of providing a unique interactive travel experience where children may interact with their parents or guardians, their dolls and an electronic medium or a device such as a computer, a tablet or a phone for accessing an educational travel software. Various embodiments of the interactive travel dolls may be known commercially as Passport Pals, Getaway Gals, Global Gals/Guys, World Travelers, Tourist Tykes, Travel Tykes, or Travel Tots.

In various embodiments, the dolls may portray eight to ten year old girls of a variety of ethnicities—with different hair, eye and skin color. Other embodiments of dolls may portray children of a different age range, or may portray boys. In some embodiments, the dolls may be about 15 inches tall. In other embodiments, the dolls may have other sizes. In some embodiments, the doll may come packaged with a handle for easy portability. In some embodiments, the doll may be seated in an airplane seat with attached seatbelt. Various embodiments may include a carry-on bag, a travel neck pillow, a passport book with printable passport stamp stickers and an online registration card with instructions. Embodiments may include providing a variety of related clothing and accessories with the dolls or offering related clothing and accessories via an online platform or the travel software. Various embodiments of the interactive travel dolls may become collectible items.

With each doll, a child may receive an identification code that is unique to that particular doll. The code may indicate the specific ethnicity and attributes of that doll. In one embodiment, the first 10 digits of the identification code may indicate the identification number of the doll. The second three digits may denote the specific characteristics of the doll. For example, Doll 0123456789-001 indicates that it's “Amy Smith's doll” that she has named “Lilly” and the last three digits 001 indicate that she purchased an African American doll with dark black curly hair, and dark brown eyes. In some embodiments, the identification code may comprise a plurality of identification numbers. Various embodiments may include a registration card having a unique identification code. The registration card may come with the doll so that owners, such as a parent and child, may go online and register their doll with the manufacturer. The registration card and the unique identification code of the doll may also be used to establish the doll's name and birthdate.

Various embodiments may further include travel companion pets, such as dogs, cats, birds, turtles, pigs, and hamsters. A pet may come with its own collar, tag, leash, carrier, and vaccination/medical records booklet. Like the dolls, the pets may have an identification code which may include one or more identification numbers. In one embodiment, a pet may have an identification number that the owners may use to register online the pet's name and birthday; and another set of numbers to indicate the type of pet and its physical characteristics. Embodiments may include providing a variety of pet accessories and personalization features with the pets or offering pet accessories or personalization via an online platform or the travel software.

Embodiments of the dolls may also come with instructions to help the owners, for example a parent and child, know how to best use and interact with the doll. The instructions may tell parents that for “the best experience” the child should compete the online registration form and a questionnaire. A registration card may come with the doll so that parent and child can go online and register their doll with the manufacturer. Not only they may establish their doll's name and birthdate, but they may be able to input the doll's travel preferences. For example, the owners may specify whether the doll prefers an aisle or window seat, vegetarian or Kosher meals, how they want to receive their boarding pass—text, email or print, traveling alone or with someone, etc. The owners may further be prompted to answer a market driven questionnaire about their travel aspirations. The consumer input received may be used to design future travel experiences based on the doll owner's responses and collectively used by the interactive travel experience provider (such as manufacturer's marketing department) to create trips that cater to all owners or collectors of the dolls.

In one embodiment, four trips may be proposed by the provider throughout the calendar year. The four trips may correspond to the four seasons. In one example, one trip may be geared towards a USA destination, two international trips may be offered, and one philanthropic trip may be recommended. In addition, special/novelty trips during holidays may also be offered throughout the year. For example, a ski trip may be offered during the holidays. In another example, a quick trip to Washington DC to enjoy the Fourth of July fireworks on the Mall lawn may be offered.

Once the owner has registered the doll, the provider may email or text a welcome letter addressed to the doll. The welcome letter may mention upcoming trips and schedules as if the doll were going on a real trip. The owner may have the option to specify whether the doll is traveling alone or with other dolls. The owner may choose the doll's seat and specify food preferences for long trips. Weather advisories and travel alerts may come addressed to the doll based on the type of preference the owner selected during the registration process. The preferences may be changed at any time. The owner may also select how often communication is received from the provider to the owner of the doll.

During and after a trip to a destination, the owner/child has the opportunity to print out or receive via mail, point of entry and exit stamped passport stickers from that destination (for example a particular country) for his or her doll's passport book. The stamped passport stickers will show that the doll has visited that locale. Embodiments of the dolls may come with a passport and labels for the owner to print out their doll's passport stamps. Should the doll's owner not have a printer accessible, they may be able to submit a request to the manufacturer for a passport sticker to be mailed to him or her. Passport stickers may become collectibles. Passport stickers may also serve as indicators of the various trips offered during a year, for example, Paris trip Spring 2019, Mexico trip Fall 2020, Holiday Switzerland trip 2020, etc.

The night before a scheduled trip, the parent is encouraged to take their child's doll in its carryon package (for example, plane seat) for safe travel. During the planned trip, the doll will remain hidden from the child; the child may follow the doll virtually online as the doll begins her journey. During the trip, the provider may send out time of arrival travel updates, any flight delays, gate changes, and weather alerts. The owner may receive an itinerary of where the doll will be each day and night. Based on the information provided by the owner prior to the trip, the doll will be displayed as traveling alone or with one or more other dolls in that location. For limited time periods, doll accessories may be offered online for the parent/guardian to purchase prior to or during the scheduled trip. For example, if the doll is visiting Paris, France, than photos displaying the doll sitting at a café with the Eiffel Tower in the background may be available to print or download from the computer. When the doll visits a store on the Champs-Élysées, the owner may be offered to purchase online a list of various Parisian outfits, accessories and souvenirs. Some items may be complimentary (free) online, such as photos of the doll in various locations. Other items may be available for sale, such as an English to French dictionary and a history book of France aimed at younger audiences. Some doll accessories may be available throughout the year online and considered regular stock items, such as personalized travel neck pillow and blanket, earbuds, and hat box. Other items may be deemed special or limited in nature, such as destination souvenirs geared toward the country being explored.

In some embodiments, various other brands and manufacturers may be allowed to cross-market and advertise specialty/limited items to owners of the dolls. For example, an airline or hotel may offer a real life trip or offer its logo for increased brand awareness and sales. In another example, a luggage manufacturer may choose to lend its brand to the doll's available accessory line.

As discussed above, each doll may have its own unique identification code. In one embodiment, the first digits of the doll identification code may indicate its unique identification number; the last digits following a dash will reflect a doll's different ethnicity and physical features. For example, all dolls ending in -001 may have a certain skin color, eye color, hair style and color, and complimentary outfit and may be scanned into the manufacturer's main data storage prior to sales for record keeping and marketing purposes later. Each doll's identification code may be accessed throughout the doll's lifetime just like a passport number. The identification code corresponds exactly to the image of the doll. This identification process will be used for scheduled trips. The identification code will be used to identify individual dolls when multiple dolls are traveling together. For example, Jenny's doll (0123456789-002) which is a Caucasian, blond, blue-eyed, fair-skinned doll, is traveling with Amy's doll (0123456788-003) which is an Asian, black haired, brown eyed, light-skinned doll. In some embodiments, up to ten dolls may share a particular travel event experience. For example, one doll may be photographed with the Eiffel Tower in the background or a group of dolls, up to ten dolls, may be photographed with the Eiffel Tower in the background.

Embodiments provide many benefits to children. Embodiments provide an interactive platform that encourages parent/guardian and child playtime together. Embodiments may provide a child access to a “controlled” social media platform similar to older siblings, friends, and parents/guardians. For example, each doll has may have its own social media page, such as Facebook or Instagram page run by the manufacturer. Embodiments of the interactive travel dolls educate the child and bring awareness about other countries and cultures. Accessories from destination trips allow the child to further engage and learn about other places and cultures. Accessories from destination trips are specialty items and/or limited items that may become collectibles over time.

Embodiments may promote philanthropy and teach children early on about philanthropy. At least some of the offered trips may be philanthropic in nature, to spread peace and goodwill towards others less fortunate in the world. In one embodiment, at least one trip a year may be offered by the provider toward a noteworthy cause to raise awareness and educate the public about a particular action, phenomenon or condition. Further, at least part of the sale proceeds, such as proceeds from sales related to a philanthropic trip, may be provided to an organization or country in need. For example, a Unicef trip may be offered to support a poor country. In another example, a wildlife safari may be offered to raise funds for the World Wide Fund for Nature.

This disclosure is not limited to the particular systems, devices and methods described, as these may vary. The terminology used in the description is for the purpose of describing the particular versions or embodiments only, and is not intended to limit the scope.

Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiment.

1. An interactive travel doll comprising:
a doll; and
a user interface configured to receive consumer input and to provide a travel plan for the doll based on the consumer input.

2. The interactive travel doll of claim 1, wherein the consumer input comprises at least one of travel preferences and responses to a market driven questionnaire about travel aspirations.

3. The interactive travel doll of claim 1, wherein the travel plan comprises at least one trip.

4. The interactive travel doll of claim 3, wherein the at least one trip comprises one or more of a USA destination, at least one international destination and a philanthropic trip.

5. The interactive travel doll of claim 1, wherein the user interface is further configured to display an image of the doll at a destination within the travel plan.

6. The interactive travel doll of claim 1, wherein the user interface is further configured to provide real time travel updates during a trip within the travel plan.

7. The interactive travel doll of claim 1, further comprising a passport for the doll.

8. The interactive travel doll of claim 7, wherein the user interface is further configured to provide passport stamps corresponding to one or more destinations within the travel plan.

9. The interactive travel doll of claim 1, wherein the doll has a unique identification code.

10. The interactive travel doll of claim 9, wherein the unique identification code is associated with an image of the doll.

11. The interactive travel doll of claim 10, wherein the user interface is configured to display the image of the doll during travel based on the unique identification code.

12. The interactive travel doll of claim 1, wherein the user interface further comprises a social media site.

13. The interactive travel doll of claim 1, further comprising an airplane seat for the doll.

14. The interactive travel doll of claim 1, further comprising a travel companion pet for the doll, wherein the travel companion pet has a unique identification number.

15. A method of providing an interactive travel experience, the method comprising:
providing a doll having a unique identification code;
receiving consumer input comprising at least one of travel preferences and responses to a market driven questionnaire about travel aspirations; and
generating a travel plan comprising at least one trip for the doll based on the consumer input.

16. The method of claim 15, further comprising displaying an image of the doll during the at least one trip based on the unique identification code.

17. The method of claim 16, further comprising:
providing a passport for the doll; and
generating passport stamps corresponding to the at least one trip.

18. The method of claim 15, wherein generating a travel plan comprises generating at least one of a trip to a USA destination, a trip to an international destination and a philanthropic trip.

19. The method of claim 15, further comprising providing real time travel updates during the at least one trip.

20. The method of claim 15, further comprising providing access to a social media platform for the doll.
